(19) United States
(12) Patent Application Publication
(10) Pub. No.: US 2013/0254111 A1
(43) Pub. Date: Sep. 26, 2013

(54) SYSTEM AND METHOD FOR FORMULA CALCULATION AND PAYMENT AUTHORIZATION WITH ELECTRONIC SIGNATURES

(71) Applicant: DOCUSIGN, INC., Seattle, WA (US)

(72) Inventors: Thomas H. Gonser, Bellevue, WA (US); Donald G. Peterson, Kirkland, WA (US); Doug Rybacki, Seattle, WA (US); Aaron Michael Wald, Seattle, WA (US); Ryan Russell Thomas, Sammamish, WA (US)

(73) Assignee: DOCUSIGN, INC., Seattle, WA (US)

(21) Appl. No.: 13/838,754

(22) Filed: Mar. 15, 2013

Related U.S. Application Data
(60) Provisional application No. 61/614,383, filed on Mar. 22, 2012.

(51) Int. Cl. G06Q 20/38

(52) U.S. Cl. CPC G06Q 20/3825
USPC 705/44

(57) ABSTRACT

Techniques for electronic signature processes are described. Some embodiments provide an electronic signature service (“ESS”) configured to facilitate the creation, storage, and management of electronic signature documents. The ESS may facilitate payment processing via an electronic signature document that includes or is associated with a payment form. When the signature document is presented to a user for signature, the payment form collects payment data (e.g., card type, account number, name) that is used by the ESS to process payment upon completion of the signing process.

### PRIORITY CLAIM

This application claims the benefit of U.S. Provisional Application No. 61/614,383, filed Mar. 22, 2012.

### FIELD OF THE INVENTION

The present disclosure relates to systems and methods for electronic signatures and, more particularly, to systems and methods for incorporating payment processing and dynamic formula calculation with online electronic document signing.

### BRIEF DESCRIPTION OF THE DRAWINGS

Preferred and alternative examples of the present invention are described in detail below with reference to the following drawings:

FIG. 1 illustrates an example block diagram of an example embodiment of an electronic signature service;

FIGS. 2A-2G illustrate user interface screens for configuring a payment form according to example embodiments;

FIGS. 3A-3B illustrate user interface screens for configuring a formula field according to an example embodiment;

FIG. 4 is a flow diagram of an example process for facilitating a payment in the context of an electronic signature transaction; and

FIG. 5 is a block diagram of an example computing system for implementing an electronic signature service according to an example embodiment.

### DETAILED DESCRIPTION OF THE PREFERRED EMBODIMENT

Embodiments described herein provide enhanced computer- and network-based systems and methods for facilitating electronic signatures. Example embodiments provide an electronic signature service (“ESS”) configured to facilitate the creation, storage and management of documents and corresponding electronic signatures. Using the ESS, a first user (a “sender”) can provide or upload a document to be signed (“a signature document”), while a second user (a “signer”) can access, review, and sign the uploaded document.

Some embodiments of the ESS facilitate payment processing via an electronic signature document. In one embodiment, an electronic signature document includes or is associated with a payment form (also called a “PayForm” in one embodiment), field, or element. When the signature document is accessed by a signer, the signer is presented with information about the payment (e.g., payment amount, payee) and in response provides payment data as requested by the payment form, such as name, address, account number, expiration date, security code, and the like. Then (or at a later time, such as at the conclusion of the signing process), the signer is asked to confirm the payment being requested. If the user confirms payment, the payment is processed by transmitting the signer's payment data to a payment processor or mechanism, such as PayPal, a credit card network, a bank, debit card, electronic funds transfer, wire transfer, automated clearing house (ACH), or the like. Upon completion of the signing/payment process, the ESS securely stores information related to the signature process, including the signer's signature and payment data, including date, time, account information, verification codes, confirmation codes, and the like.

In some embodiments, an electronic signature document may include one or more formula fields. A formula field may include a formula or mathematical expression that is calculated, evaluated, or otherwise determined at some time after the creation of the field, such as during document signature. In one embodiment, a payment form associated with an electronic signature document includes one or more formula fields so that payment particulars (such as payment amount or date) can be dynamically determined at or about the time at which the signer signs the document and authorizes the corresponding payment. A formula field may include a formula or expression comprising one or more values (e.g., numbers, characters, strings, dates), references to other fields, mathematical operators (e.g., plus, minus, greater-than, less-than), logical operators (if, and, or, not), and the like. In some embodiments, a formula field may also include rules, directives, or instructions for processing the field, for handing circular references, for responding to errors, or the like.

The described payment form techniques merge payment processing with the execution (signature) of documents and forms in a secure online environment. Payment forms can be created without programming, and can be added to any kind of document. These documents can be sent out for signature (e.g., via email), or posted on a Web site for customers to access, complete and pay. Payment forms thus allow any document to create or initiate a payment transaction. The document creator need only associate a payment form with the document, there is no need to set up an e-commerce Web site or program specific interactions with a payment processor. This means the e-commerce “surface area” of a business can be expanded from only credit cards on an HTML shopping cart to any document that the business may have. This delivers a dramatic improvement in security, control and added convenience for the consumer.

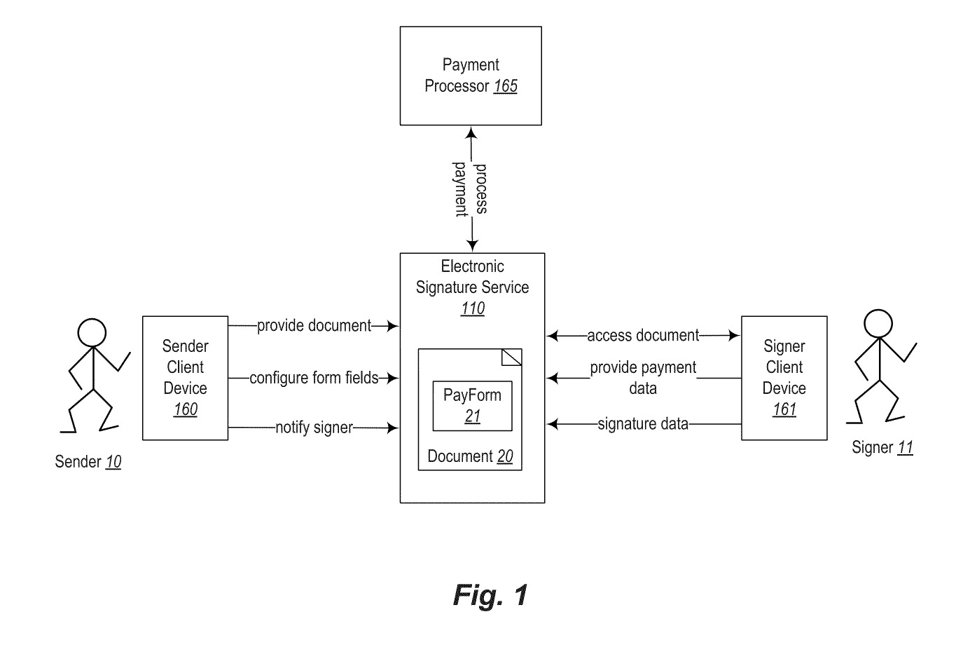

FIG. 1 illustrates an example block diagram of an example embodiment of an electronic signature service. In particular, FIG. 1 depicts an ESS 110 utilized by a sender user 10 and a signer user 11 to perform an electronic signing of a signature document 20.

In the illustrated scenario, the sender 10 operates a sender client device 160 in order to provide (e.g., upload, transmit) an electronic document 20 (e.g., an invoice, contract, or agreement) to the ESS 110, where it is securely stored. The electronic document includes a payment form (“PayForm”) 21 that is configured to facilitate the processing of a payment associated with the underlying document 20.

The payment form 21 may include multiple fields related to payment processing, including name, address, account number, card expiration date, security code, item description(s), quantity, payment amount, and the like. As noted, at least some of the fields may be or include formula fields such as formulas or mathematical expressions that are calculated at a later time. For example, a payment amount field may be a formula field that is based on an item price, a local tax rate, and shipping cost, all of which may be fields contained within the document 20 and/or provided by some third-party system, such as an electronic commerce system, a customer relationship management system, or the like.

After configuring the payment form field 21, the signer 11 accesses the document 20. In one embodiment, the sender 10 notifies the signer 11, such as by causing the ESS 110 to send to the signer 11 a message (e.g., an email) that includes a reference (e.g., a URL) to the document 20 maintained by the ESS 110. As another example, the sender 10 may include the document 20 in an email or other message transmitted directly to the signer 11. As a further example, the document 20 may be automatically presented to the signer 11 as part of a transaction. For example, an e-commerce system may cause the document 20 to be presented or transmitted to the signer 11 during or as part of a transaction for a good/service purchased via the e-commerce system or a corresponding Web site.

Typically, the signer 11 operates a Web browser or other client module executing on the signer client device 161 to access and review the document 20 via the ESS 110. For example, if the signer 11 receives an email that includes a link to the document 20, the signer can click the link to visit the ESS 110 in order review and sign the document 20. If instead the signer 11 receives the document 20 itself directly from the sender 10, opening the document will also cause the user to visit the ESS 110 to provide the required signature information.

When the signer 11 accesses the document 20, any formula fields within the document 20 and/or payment form 21 are evaluated, calculated, or otherwise resolved. Formula fields may be calculated locally (e.g., by a JavaScript engine or other interpreter executing on the signer client device 161) and/or remotely (e.g., by a component of the ESS 110) with respect to the signer client device 161. Next, the user provides payment data as requested via the payment form 21. When the document 20, payment form 21, and related data have been modified and reviewed to the satisfaction of the signer 11, the signer attaches (or provides an indication or instruction to attach) his electronic signature to the document 20. At this time (e.g., just before or after signing), the signer may also be asked to confirm the payment details.

Once the signing has been completed, various approaches to processing the payment are contemplated. In one approach, after the signer 11 attaches his signature, the signer initiates payment through the payment processor 165. This may include transmitting payment data (obtained from the payment form 21) from the signer client device 161 to the payment processor 165 without involvement of the ESS 110, such as without transmission through the ESS 110. The payment processor 165 then returns status information, indicating whether the payment could be processed successfully, transaction identifiers, and the like. Then, the signer 11 can confirm the completed transaction or cancel in order to start the process over.

In another approach to payment processing, payment is facilitated by the ESS 110. For example, after the signer 11 attaches his signature (or after the signer 11 has confirmed payment), the ESS 110 initiates a payment according to the payment form 21 and the corresponding data provided by the signer 11. In particular, the ESS 110 may transmit data gathered via the payment form 21 to a payment processor 165. The payment processor 165 effectuates a payment using known techniques, such as a credit card charge, an account debit, an electronic funds transfer, or the like. Upon processing the payment, the payment processor 165 returns status information (e.g., transaction number, completion status, verification code) to the ESS 110, where it is stored in association with signature and payment data obtained from the signer 11. The ESS 110 may also generate and/or provide a confirmation message for the signer 11.

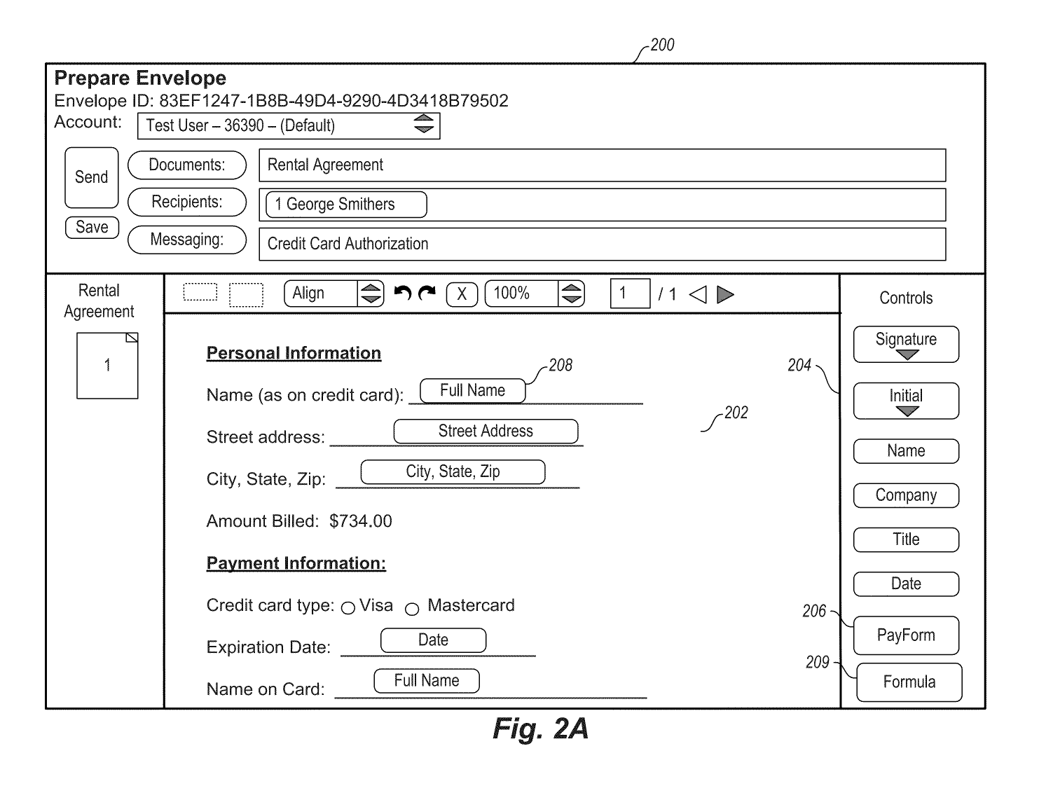

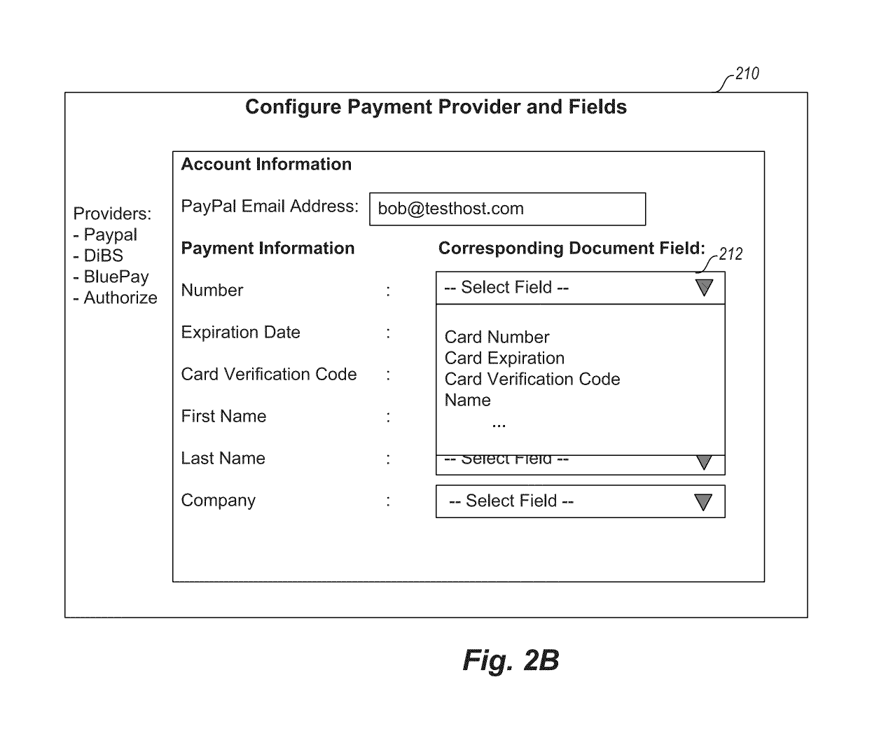

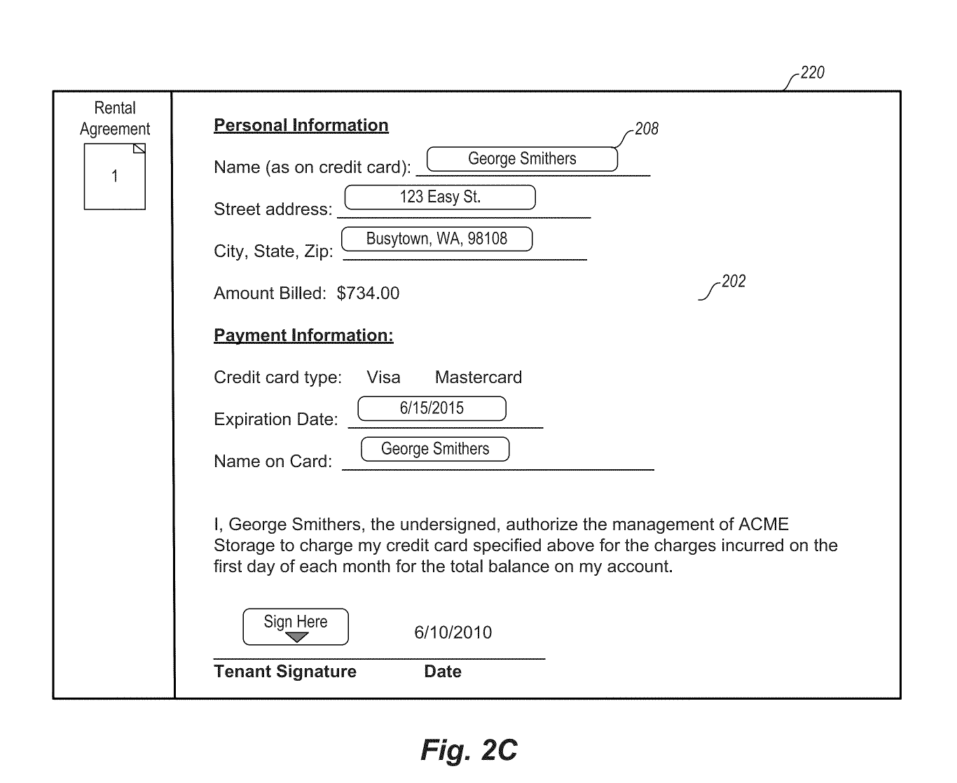

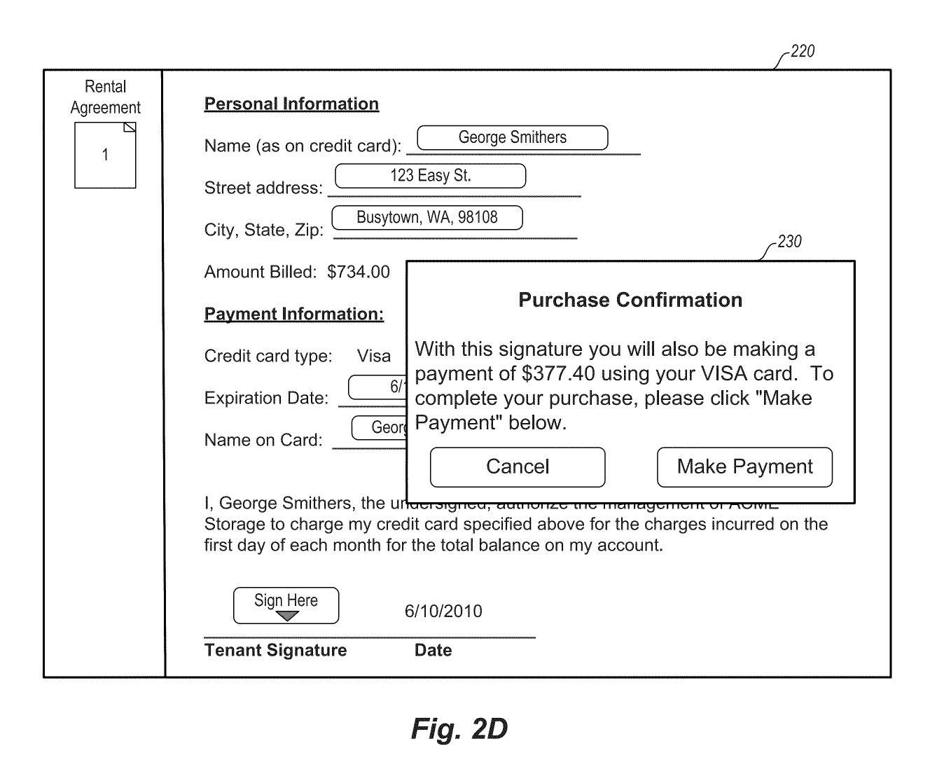

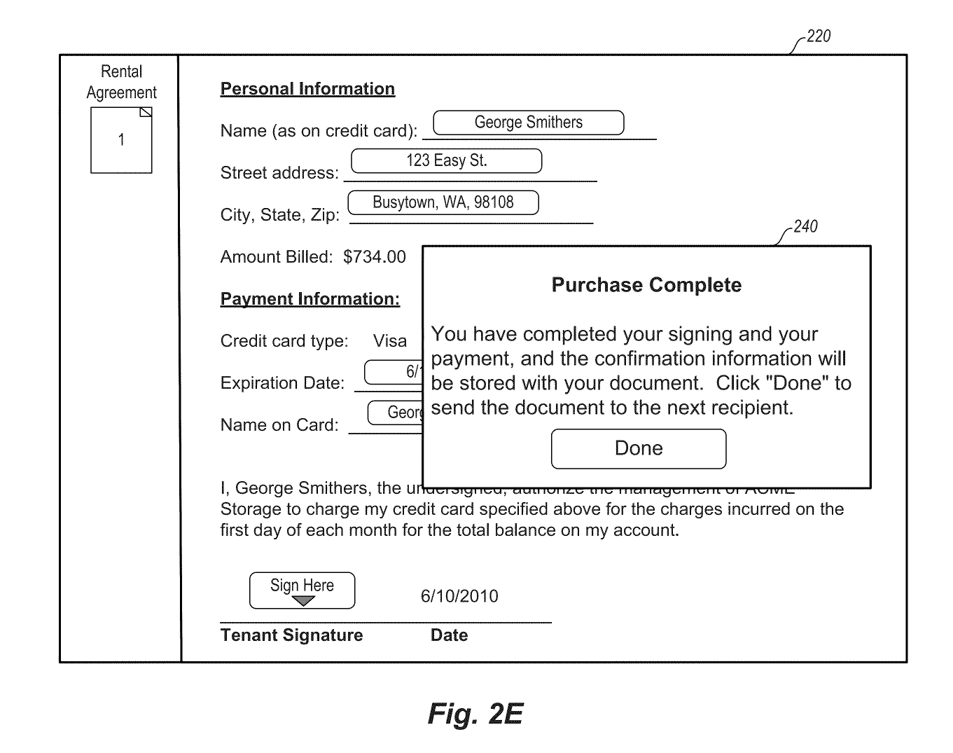

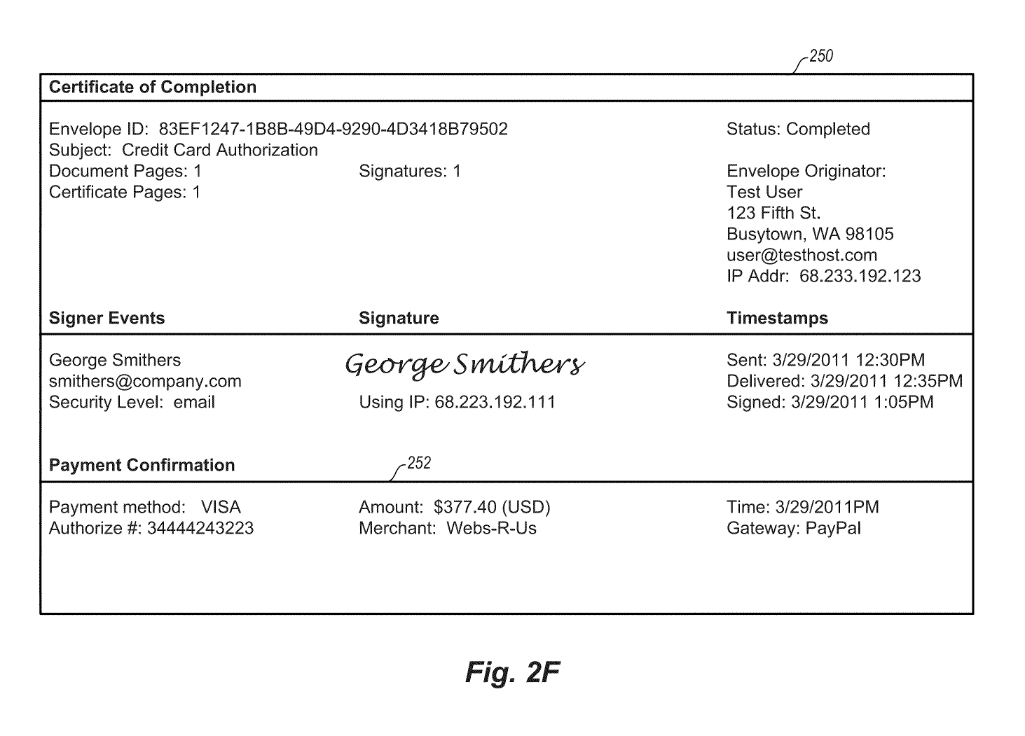

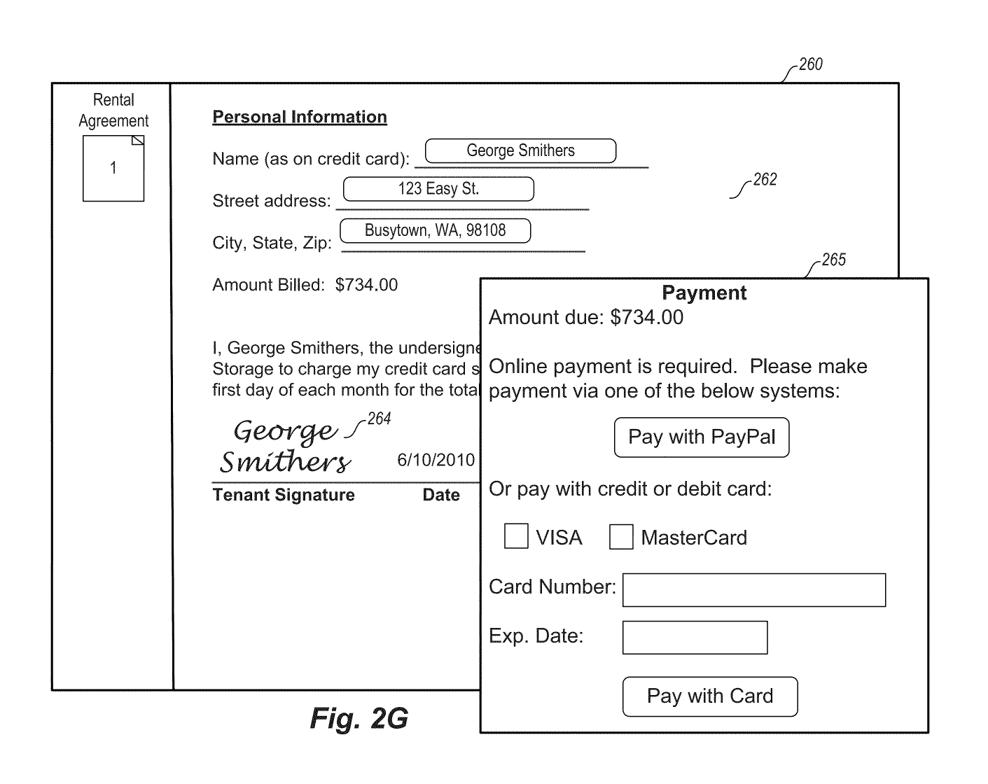

FIGS. 2A-2F illustrate user interface screens for configuring a payment form according to example embodiments.

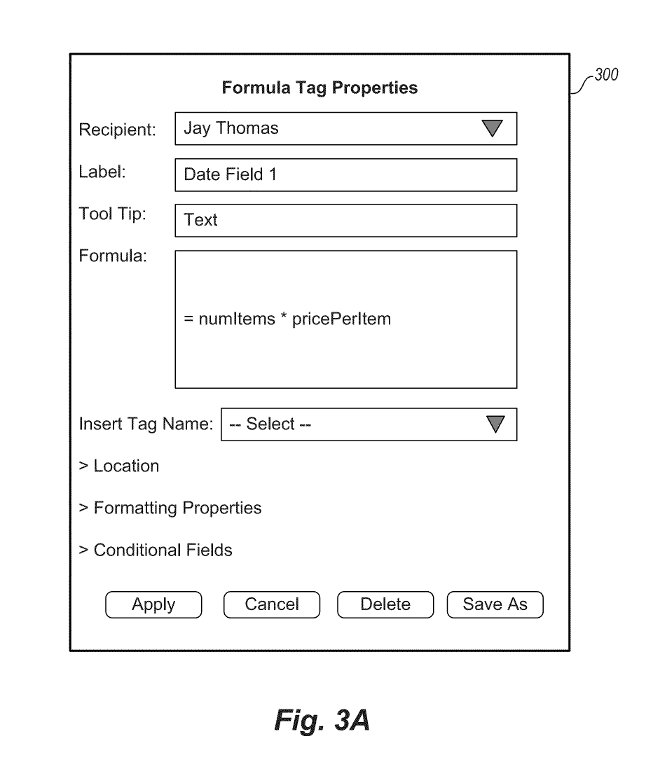

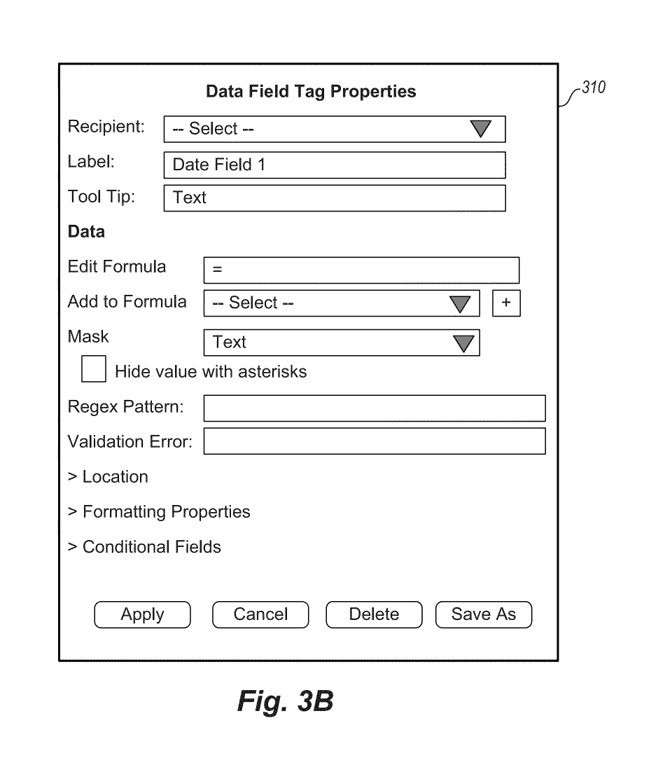

FIG. 2A illustrates a screen 200 configured for preparing an electronic signature document 202 and its corresponding envelope (e.g., information regarding sender, signer, messages). A user can drag and drop signature controls from the palette 204 onto the document 202. As one example, the user has placed a name control 208 at a location on the document 202 where a person's name is requested. As another example, the user can drag a payment form control 206 onto the document 202 in order to associate a payment form therewith. In addition, the user can drag a formula control 209 onto the document 202 to associate a formula field therewith, as described further with respect to FIGS. 3A-3B, below.

FIG. 2B illustrates a screen 210 for configuring a payment form and a corresponding payment provider/gateway. The screen 210 is operated by a user who desires to receive payment via a payment form. Upon dragging the control 206 onto the document 202 (FIG. 2A), the screen 210 is presented so that the user can select the appropriate payment provider (e.g., PayPal, DiBS, etc.) and specify the fields that are required from the signer. The screen 210 may also or instead be presented as part of a global configuration for a user account, so that whenever the control 206 is dragged onto a signature document, the settings defined in screen 210 will be used.

One of the purposes of the screen 210 is to provide the user with a set of options for a particular gateway account, and to map the required fields for that gateway (e.g., card number, expiration date, name) to corresponding fields in the signature document 202. In this example, the user provides his account details, such as by providing his account name (bob@testhost.com), thereby providing the payment processor a destination for crediting or depositing payments. The screen 210 also displays, on the left side, payment information items that are required by the payment processor, including card number, expiration date, and the like. On the right, the screen 210 displays a drop down menu corresponding to each of the payment information items on the left. Each of the drop down menus includes a list of fields that are defined in the signature document 202. The user can use the drop down menus to select or specify a field from the signature document 202 that will operate as a source of data for a corresponding payment information item required by the payment processor. For example, the user is operating menu 212 to specify that a field named Card Number in the document 202 should correspond to the payment information field named Number.

FIG. 2C illustrates a screen 220 configured for signing the electronic signature document 202. The screen 220 may be presented by or within a Web browser operated by a signer of the document 202. In this example, the signer has activated the signatures controls (e.g., control 208) to specify required information, such as his name. In addition, the user has also provided the information (e.g., billing address, name on credit card, card number) required by a payment form that has been associated with the document 202 as described above.

FIG. 2D illustrates a confirmation screen 230 that is presented in response to the signer's completion of the signature document 202 presented in screen 220. The confirmation screen 230 prompts the signer to confirm the payment associated with the payment form of document 202.

FIG. 2E illustrates a completion screen 240 that is presented in response to the signer's confirmation received via the confirmation screen 230, above. Note that the payment may be processed at different times depending on the workflow associated with the document 202. For example, if the document requires one or more additional signatures, the payment may be delayed until those signatures are obtained. In such a circumstance, the payment information will be held by the ESS 110 (or some other entity) until the workflow is complete and all required signatures have been obtained (“envelope completion”). The permissible length of time for gathering the required signatures may be based on a time limit associated with the document 202. For example, the document sender may associate a time of 24 hours, such that if not all signatures are gathered within that time, a payment will not be processed and/or a held payment will automatically be canceled or withdrawn.

FIG. 2F illustrates a certificate of completion 250. The certificate of completion 250 includes information regarding the completion of the signature document 202. The certificate 250 also includes payment confirmation information 252, such as card type, number, amount, and the like. The certificate 250 may be used to prove, validate, confirm, or otherwise demonstrate that a payment was made and that a document was signed.

FIG. 2G illustrates a screen 260 configured for signing an electronic signature document 262. The illustrated scenario is similar to that described with respect to FIG. 2C, above. In this example, the user does not enter payment information into the document 262 (as shown in FIG. 2C). Instead, after the user attaches his signature 264, a payment screen 265 is presented. The user then selects one of the presented payment options (in this example, PayPal or credit card payment), provides the requested payment information, and initiates payment. Once the payment is processed, control returns to the screen 260, where the user may be given an opportunity to confirm his signature and receive a copy of the signed, completed document 262.

FIGS. 3A-3B illustrate user interface screens for configuring a formula field according to an example embodiment. The user interface screens described herein may be presented in a Web browser (e.g., as Web pages provided by the ESS) or as a standalone executable (e.g., a desktop application, a mobile app), or the like.

FIG. 3A illustrates a screen 300 for configuring formula tag properties. The screen 300 may be presented in response to placement of a formula control onto a signature document (e.g., formula control 209 shown in FIG. 2A). A user operates the screen 300 to specify properties and formulas with respect to a particular formula field. For example, the user can specify the label, tool tip, and formula. A variety of formulas are supported, mathematical expressions that include constants (e.g., 9.5, “test”), variables, mathematical operators (e.g., +, −, *, /), logical operators (e.g., if, and, or, not), function calls (e.g., date( ), time( ), formatting operators (e.g., fixed width display), and the like. In some cases, the formula may include arbitrary code sequences, such as JavaScript code blocks. Also, values may be referenced from within a single document (e.g., by accessing a number of items field from a purchase order), from another document (e.g., by accessing an account number from a customer intake document), from an arbitrary data source (e.g., via a URL access to a Web service), or the like.

FIG. 3B illustrates a screen 310 for configuring data field tag properties. The screen 310 may be presented in response to placement of a data field control onto a signature document. In some embodiments, formulas may be associated with data fields, such as a data field for entering a number of items in a purchase order document.

The payment form techniques described herein provide numerous benefits. To business users, they provide stronger evidence with the respect to the purchaser, because the purchaser may be authenticated (possibly with multi-level authentication) prior to paying, and the purchaser is explicitly signing an agreement when he pays. In addition, the transaction is performed in a single step that combines agreement and paying, rather than splitting these operations possibly across distinct user interfaces. Further, the number of charge-backs may be reduced because transactions are signed, meaning that purchasers will have a harder time repudiating their purchase. Also, business users need not integrate payment modules or pay for expensive custom programming to take advantage of payment forms.

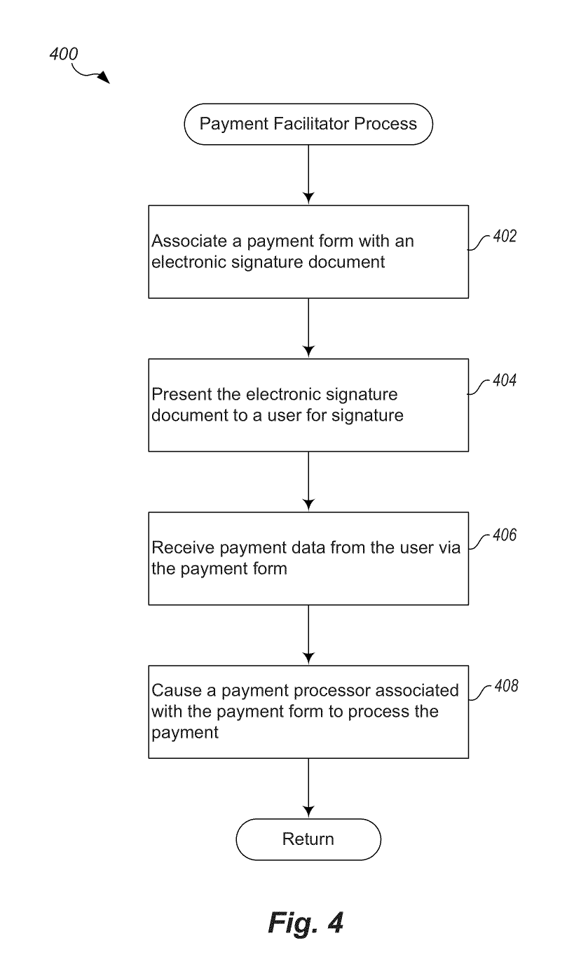

FIG. 4 is a flow diagram of an example process 400 for facilitating a payment in the context of an electronic signature transaction. The process of FIG. 4 may be performed by the ESS 110.

The illustrated process begins at block 402, where it associates a payment form with an electronic signature document. The payment form is configured to obtain payment data from a user and also typically has an associated payment processor.

At block 404, the process presents the electronic signature document to a user for signature. Presenting the document to the user may include transmitting the document (e.g., via an email) or transmitting an email with an identifier (e.g., link) that can be used to access the document at the ESS.

At block 406, the process receives payment data from the user via the payment form. When the user interacts with the document to review and sign it, the user also provides payment data requested by the payment form. This payment data is received by the process and used to initiate a payment with the payment processor.

At block 408, the process causes a payment processor associated with the payment form to process the payment. The process may delay payment processing until one or more conditions occur, such as additional signatures are obtained, a time period expires, or the like.

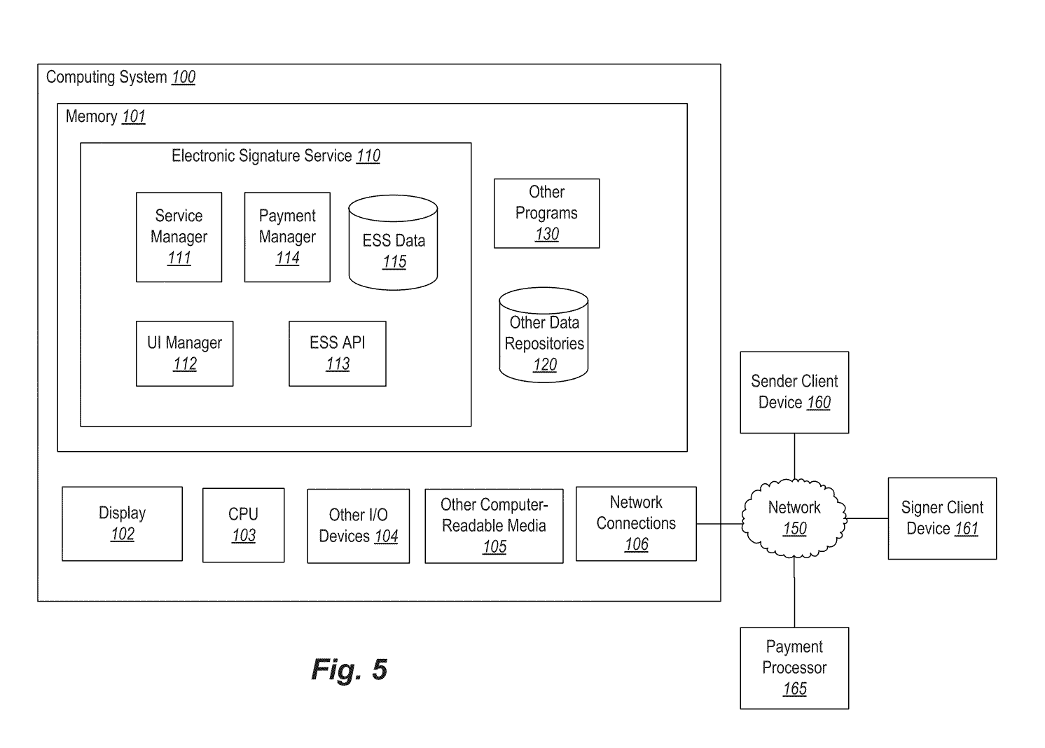

FIG. 5 is a block diagram of an example computing system for implementing an electronic signature service according to an example embodiment. In particular, FIG. 5 shows a computing system 100 that may be utilized to implement an ESS 110.

Note that one or more general purpose or special purpose computing systems/devices may be used to implement the ESS 110. In addition, the computing system 100 may comprise one or more distinct computing systems/devices and may span distributed locations. Furthermore, each block shown may represent one or more such blocks as appropriate to a specific embodiment or may be combined with other blocks. Also, the ESS 110 may be implemented in software, hardware, firmware, or in some combination to achieve the capabilities described herein.

In the embodiment shown, computing system 100 comprises a computer memory (“memory”) 101, a display 102, one or more Central Processing Units (“CPU”) 103, Input/Output devices 104 (e.g., keyboard, mouse, CRT or LCD display, and the like), other computer-readable media 105, and network connections 106 connected to a network 150. The ESS 110 is shown residing in memory 101. In other embodiments, some or all of the components of the ESS 110 may be stored on and/or transmitted over the other computer-readable media 105. The components of the ESS 110 preferably execute on one or more CPUs 103 and manage electronic signature processes including payment processing as described herein. Other code or programs 130 (e.g., an administrative interface, a Web server, and the like) and potentially other data repositories, such as data repository 120, also reside in the memory 101, and preferably execute on one or more CPUs 103. Of note, one or more of the components in FIG. 5 may not be present in any specific implementation. For example, some embodiments may not provide other computer readable media 105 or a display 102.

The ESS 110 includes a service manager 111, a user interface (“UI”) manager 112, an electronic signature service application program interface (“API”) 113, a payment manager 114, and an electronic signature service data store 115.

The ESS 110, via the service manager 111 and related logic, generally performs electronic signature-related functions for or on behalf of users operating a sender client device 160 and/or a signer client device 161. In one embodiment, a sender operating the sender client device 160 provides (e.g., transmits, uploads, sends) a document to be electronically signed to the ESS 110. The ESS 110 stores the document securely in data store 115. Secure document storage may include using cryptographic techniques to detect document tampering, such as generating hashes, message digests, or the like.

A signer operating the signer client device 161 accesses, reviews and signs the document stored by the ESS 110. In some embodiments, the ESS 110 transmits images or some other representation of the document to the signer client device 161, which in turn transmits signature data including an indication of the signer's signature (or intent to sign) to the ESS 110. The ESS 110 then securely stores the provided signature data in association with the document in the data store 115.

The payment manager 114 facilitates payments via electronic signature documents as discussed herein. Initially, a sender or other user operating the sender client device 160 may associate a payment form and optionally one or more formula fields with an electronic signature document stored in the data store 115. Then, a signer operating the signer client device 161 may provide payment data, such as credit card information, via a payment form associated with the signature document. Then, the payment manager 114 forwards the provided payment data to the payment processor 165 to cause a payment to be processed. The payment manager 114 further securely stores in the data store 115 payment data received from the signer client device 161 as well as transaction information received from the payment processor 165.

The UI manager 112 provides a view and a controller that facilitate user interaction with the ESS 110 and its various components. For example, the UI manager 112 may provide interactive access to the ESS 110 such that users can upload or download documents for signature, create and/or configure payment form fields or formula fields associated with or incorporated into signature documents, and the like. In some embodiments, access to the functionality of the UI manager 112 may be provided via a Web server, possibly executing as one of the other programs 130. In such embodiments, a user operating a Web browser (or other client) executing on one of the client devices 160 or 161 can interact with the ESS 110 via the UI manager 112.

The API 113 provides programmatic access to one or more functions of the ESS 110. For example, the API 113 may provide a programmatic interface to one or more functions of the ESS 110 that may be invoked by one of the other programs 130 or some other module. In this manner, the API 113 facilitates the development of third-party software, such as user interfaces, plug-ins, news feeds, adapters (e.g., for integrating functions of the ESS 110 into Web applications), and the like. In addition, the API 113 may in at least some embodiments be invoked or otherwise accessed via remote entities, such as the payment processor 165, to access various functions of the ESS 110. For example, the payment processor 165 may push or otherwise import a daily transaction log into the ESS via the API 113.

The data store 115 is used by the other modules of the ESS 110 to store and/or communicate information. The components of the ESS 110 use the data store 115 to record various types of information, including documents, signatures, payment data, and the like. Although the components of the ESS 110 are described as communicating primarily through the data store 115, other communication mechanisms are contemplated, including message passing, function calls, pipes, sockets, shared memory, and the like.

The ESS 110 interacts via the network 150 with client devices 160 and 161, and payment processor 165. The network 150 may be any combination of one or more media (e.g., twisted pair, coaxial, fiber optic, radio frequency), hardware (e.g., routers, switches, repeaters, transceivers), and one or more protocols (e.g., TCP/IP, UDP, Ethernet, Wi-Fi, WiMAX) that facilitate communication between remotely situated humans and/or devices. In some embodiments, the network 150 may be or include multiple distinct communication channels or mechanisms (e.g., cable-based and wireless). The client devices 160 and 161 include personal computers, laptop computers, smart phones, personal digital assistants, tablet computers, and the like.

In an example embodiment, components/modules of the ESS 110 are implemented using standard programming techniques. For example, the ESS 110 may be implemented as a “native” executable running on the CPU 103, along with one or more static or dynamic libraries. In other embodiments, the ESS 110 may be implemented as instructions processed by a virtual machine that executes as one of the other programs 130. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the ESS 110, such as in the data store 118, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 118 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the ESS 110 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It should be apparent to those skilled in the art that many more modifications besides those already described are possible without departing from the inventive concepts herein. Moreover, in interpreting both the specification and the claims, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring one or more elements from the set {A, B, C, . . . N}, and not N in addition to one or more elements from the set {A, B, C}.

All of the above-cited references, including U.S. Provisional Application No. 61/614,383, filed Mar. 22, 2012, entitled “SYSTEM AND METHOD FOR FORMULA CALCULATION AND PAYMENT AUTHORIZATION WITH ELECTRONIC SIGNATURES” are incorporated herein by reference in their entireties. Where a definition or use of a term in an incorporated reference is inconsistent with or contrary to the definition or use of that term provided herein, the definition or use of that term provided herein governs.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for facilitating payments via electronic signature documents, comprising:
in an electronic signature service that is configured to securely store electronic signature documents and indications of corresponding signatures to those documents,
associating a payment form with an electronic signature document, wherein the payment form has an associated payment processor and is configured to obtain payment data from a user;
presenting the electronic signature document including the payment form to a user for signature;
receiving payment data from the user via the payment form; and
causing the associated payment processor to process a payment based on the payment data received via the payment form.

2. The method of claim 1, further comprising: associating a formula field with the payment form, the formula field including a mathematical expression to be evaluated when the electronic signature document is presented to the user for signature.

3. The method of claim 2, wherein the mathematical expression includes at least one operator and one or more references to other fields of the electronic signature document.

4. The method of claim 2, wherein the mathematical expression is evaluated by a client device of the user, based on at least one data item entered into a field of the electronic signature document during the signing of the electronic signature document.

5. The method of claim 1, wherein causing the associated payment processor to process the payment includes: transmitting the payment data to a third-party payment system.

6. The method of claim 5, further comprising:
receiving payment confirmation data from the third-party payment system;
storing the received payment confirmation along with signature data received from the user.

7. The method of claim 1, wherein the payment data includes at least one of a payment method, an account number, a name, an address, and/or a security code.

8. The method of claim 1, wherein the payment processor is configured to process at least one of a credit card payment, a debit card payment, an electronic funds transfer, and/or a reward points payment.

9. The method of claim 1, wherein presenting the electronic signature document includes:
transmitting an invitation email to the user, the email including a link that identifies the electronic signature document;
in response to activation of the link by the user, transmitting an image of a portion of the electronic signature document along with a module that represents the payment form and that is configured to receive payment data from the user and to transmit the received payment data to the electronic signature service.

10. The method of claim 1, further comprising:
receiving the electronic signature document from a sender; and
presenting to the sender a user interface that includes a payment form control that can be interactively dragged by the sender onto a representation of the electronic signature document, thereby associating the payment form with the electronic signature document.

11. A computer-readable medium including contents that, when executed by a computing system, facilitate payments via electronic signature documents, by performing a method comprising:
in an electronic signature service that is configured to securely store electronic signature documents and indications of corresponding signatures to those documents,
associating a payment form with an electronic signature document, wherein the payment form has an associated payment processor and is configured to obtain payment data from a user;
presenting the electronic signature document including the payment form to a user for signature;
receiving payment data from the user via the payment form; and
causing the associated payment processor to process a payment based on the payment data received via the payment form.

12. The computer-readable medium of claim 11, wherein the contents are instructions that when executed cause the computing system to perform the method.

13. The computer-readable medium of claim 11, wherein the method further comprises:
forwarding the electronic signature documents to one or more other users for signature; and
causing the associated payment processor to process the payment only after signatures have been obtained from the one or more additional users.

14. The computer-readable medium of claim 11, wherein the electronic signature document includes a formula field that is configured to evaluate a mathematical expression to determine an amount of money for the payment based on one or more data items specified in other fields of the electronic signature document.

15. The computer-readable medium of claim 14, wherein the mathematical expression further determines the amount of money based on one or more data items specified in fields in another electronic signature document.

16. A computing system configured to facilitate payments via electronic signature documents, comprising:
a processor;
a memory;
a module that is stored on the memory and that is configured, when executed by the processor, to:
provide an electronic signature service that is configured to securely store electronic signature documents and indications of corresponding signatures to those documents;
associate a payment form with an electronic signature document, wherein the payment form has an associated payment processor and is configured to obtain payment data from a user;
present the electronic signature document including the payment form to a user for signature;
receive payment data from the user via the payment form; and
cause the associated payment processor to process a payment based on the payment data received via the payment form.

17. The computing system of claim 16, wherein the module includes software instructions for execution in the memory of the computing system.

18. The computing system of claim 16, wherein the electronic signature service is further configured to:
receive the electronic signature document from a sender; and
present a Web-based interface that includes interactive controls for associating payment forms and formula fields with the electronic signature document.

19. The computing system of claim 16, wherein a sender transmits an email to the user, the email including the electronic signature document as an attachment, wherein the user interacts with the electronic signature document and the payment form upon opening the attachment, and wherein the payment is processed by transmission of the payment data from a client computer of the user to the associated payment processor without passing through the computing system.

20. The computing system of claim 16, wherein the module is further configured to: associate a formula field with the payment form, the formula field including a mathematical expression to be evaluated when the electronic signature document is presented to the user for signature.
